(19) United States
(12) Patent Application Publication
(10) Pub. No.: US 2026/0238686 A1
(43) Pub. Date: Aug. 13, 2026

(54) COMMUNICATION TECHNIQUES FOR INDUSTRIAL APPLICATIONS

(71) Applicant: Siemens Aktiengesellschaft, München (DE)

(72) Inventors: Tobias Müller, Karlsruhe (DE); Arthur Kniphoff da Cruz, Karlsruhe (DE)

(21) Appl. No.: 19/538,266

(22) Filed: Feb. 12, 2026

(30) Foreign Application Priority Data
Feb. 12, 2025 (EP) 25157425

(51) Int. Cl. H04L 65/1043; H04L 51/066; H04L 67/12; H04L 69/14; H04L 69/329

(52) U.S. Cl. CPC H04L 65/1043; H04L 51/066; H04L 69/14; H04L 69/329; H04L 67/12

(57) ABSTRACT

A gateway for communicatively coupling one or more automation devices to an industrial controller for controlling the one or more automation devices includes an application layer component that implements a communication endpoint of a control application of the industrial controller.

This application claims the benefit of European Patent Application No. EP 25157425.7, filed on Feb. 12, 2025, which is hereby incorporated by reference in its entirety.

### TECHNICAL FIELD

The present disclosure relates to the field of factory and/or process automation. The present disclosure further relates to network equipment, such as a gateway, used in the factory and/or process automation systems. The present disclosure further relates to communication techniques in the factory and/or process automation systems, automation systems in general, in which one or more automation devices are communicatively coupled and controlled by one or more industrial controllers.

### BACKGROUND

In many industrial automation systems, such as industrial plants, in addition to the demanding process automation requirements, it is also necessary to integrate automation devices, such as medium-voltage power supply switchgear, into the automation system. Automation devices acting as electrical consumers with high energy requirements are part of such plants. Automation devices known as intelligent electronic devices (IEDs) are used as protection devices for control, switching, measuring, and automation. These are intelligent devices that detect abnormal operating states and faults, and provide an autonomous reaction. This is achieved by comprehensive diagnostics and signaling as well as by safe, fast, and selective shutoff of faulty plant components. The monitoring and control of the individual consumers is performed by the mentioned automation devices, and, for example, the protection devices (e.g., the IEDs).

For data exchange within the automation system, a gateway may use one or more communication connections (e.g., S7 connections for communicating with one or more industrial controllers and the IEC 61850 MMS protocol for communication with the IEDs). A gateway may thus support a larger number of automation devices and may in addition offer high availability through redundant design. For example, a gateway may be used to connect industrial controllers with one or more IEDs, such as protection devices (e.g., switches for medium-voltage automation systems).

A gateway may thus integrate IEDs (e.g., protection devices) into an industrial control system including one or more industrial controllers. It is also suitable for redundant configurations, and may therefore be provided where increased availability requirements exist.

Depending on the technical requirements, the process data may be transmitted in both directions between the one or more automation devices and the one or more industrial controllers (e.g., cyclically or in the event of changes).

In an example embodiment, a gateway may act as an IEC 61850 MMS client for IEC 61850 MMS communication with the IEDs. The IEDs form the counterpart, the IEC 61850 MMS servers. All variables provided via IEC 61850 communication may be addressed via the gateway. Depending on the configuration, the timestamp, value, and status of the variables are transmitted. The gateway may thus communicate with the industrial controller, such as a SIMATIC PCS 7 automation system via its CP 443-1 communication module or the internal PN Ethernet interface.

### SUMMARY AND DESCRIPTION

As a result, the gateway is subject to high data security, integrity, and availability requirements. For the complete integration of the gateway into an automation system, the development of adequate communication interfaces (e.g., based on TCP/IP) is necessary. Such interfaces need sufficient processing power in order to comply with the required speed, complex data structures, required response times in the millisecond range, etc., and also to comply with the requirements of an automation system such as deterministic behavior in the 0.1-1 s range, limited CPU power, and limited network interface throughput, as well as severely limited data input/output buffer.

The scope of the present invention is defined solely by the appended claims and is not affected to any degree by the statements within this summary.

The present embodiments may obviate one or more of the drawbacks or limitations in the related art. For example, the above mentioned requirements may be met, and resources of an industrial controller may be relieved, to avoid unnecessary protocol conversions and to enable a scalable communication interface, for example, allowing for redundancy in the automation system.

According to a first aspect, a gateway for communicatively coupling one or more automation devices (e.g., one or more IEC 61850 devices) to an industrial controller for controlling the one or more automation devices is provided. The gateway includes a (e.g., computer-implemented) application layer component that implements a communication endpoint of a control application of the industrial controller.

According to a second aspect, a system for distributed automation data processing is provided. The system includes a gateway and an industrial controller, where the gateway serves for pre-processing the automation data into the application layer format.

According to a third aspect, an engineering application for generating and/or configuring a control application of an industrial controller and/or an application layer component of a gateway is provided.

According to a fourth aspect, a method of operating a gateway in an industrial automation system is provided. The method includes the acts of implementing, by an application layer component, a communication endpoint of an application layer data service of a control application of the industrial controller for controlling the one or more automation devices by terminating one or more communications links between the gateway and the one or more automation devices.

According to a fifth aspect, a computer program is provided. The computer program includes program code that when executed performs the methods acts according to any one of the previous aspects.

According to a sixth aspect, a (e.g., non-transitory) storage medium is provided. The storage medium includes the computer program according to the previous aspect.

Independent of the grammatical term usage, individuals with male, female, or other gender identities are included within the term.

### BRIEF DESCRIPTION OF THE DRAWINGS

FIG. 1 shows an illustration of an automation system including a plurality of (redundant) automation devices.

FIG. 2 shows an abstract representation of an automation system, the architecture of a gateway including application layer components in the form of function blocks on the application layer.

FIG. 3 shows a network topology of an automation system in a single device setup.

FIG. 4 shows a first embodiment of communications stacks of an automation device, a gateway, and an industrial controller in accordance with the ISO/OSI layer model.

FIG. 5 shows a second embodiment of the communications stacks of an automation device, a gateway, and an industrial controller in accordance with the ISO/OSI layer model.

FIG. 6 illustrates a communication endpoint on the gateway and the application layer component on the gateway.

FIG. 7 illustrates the application layer integration concept of an automation system with hardware redundant gateways.

FIG. 8 illustrates redundancy and single mode setup of gateway(s) and industrial controller(s), where each line represents between the gateway(s) and the industrial controller(s) represents a TCP/IP connection.

FIG. 9 shows a sequence diagram of the communication between an automation device, a gateway, an industrial controller, and an engineering station.

### DETAILED DESCRIPTION

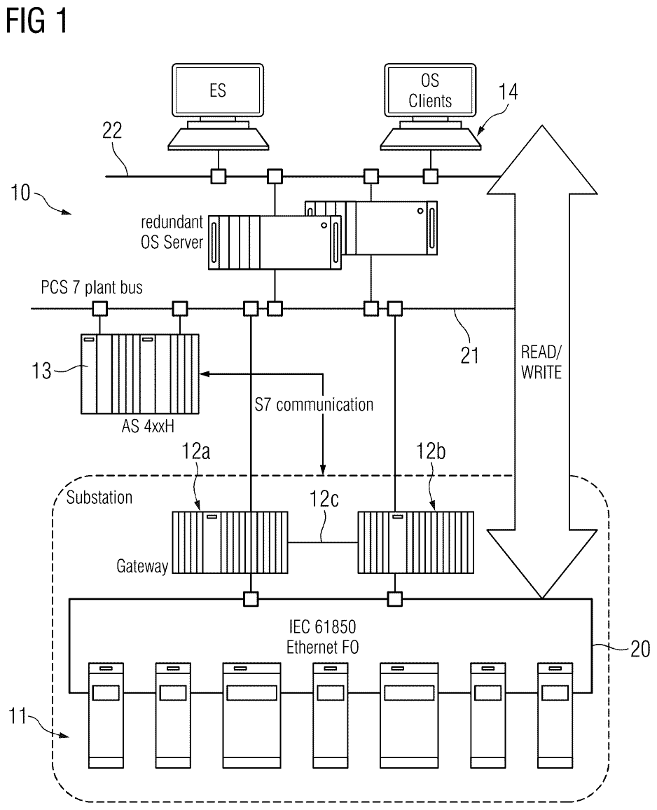

FIG. 1 shows an illustration of an automation system 10 including a plurality of automation devices 11. The automation system 10 includes a plurality of communication networks 20, 21, 22 such as a process bus connecting process-level IEDs and a station bus connecting station-level IEDs, and, for example, to one or more industrial controller 13. Alternatively, other bus or network systems may be present or may be used to communicatively couple the automation devices, such as the IEDs. The same applies for the station bus instead of which any network and/or network protocol may be used to communicatively coupling network nodes. Thus, as shown in FIG. 1, the automation devices 11 are coupled via a first network 20 using a first communication protocol. This first network 20 is coupled to a second network 21 via one or more gateways 12a, 12b. A gateway 12a, 12b is a piece of networking hardware and/or software used in telecommunications networks that allows data to flow from one discrete network to another. The gateway 12a, 12b may be regarded as a network node and connects two networks 20, 21 with different transmission protocols. Such a gateway 12a, 12b thus serves as entry and exit points for a network, as all data is to pass through or communicate with the gateway 12a, 12b before being forwarded.

The automation system 10 of FIG. 1 includes redundancy in the form of a first gateway 12a and a second gateway 12b connected to the first network 20 and the second network 21. Such a redundant gateway 12a, 12b may be created with two single gateways 12a, 12b. Further, a hardware redundant industrial controller 13 is present in the automation system 10 shown in FIG. 1. Further, a redundant operator system 14 for a user to monitor and/or control the automation system 10 is provided.

The automation system 10 may be implemented including a PCS 7 plant bus (e.g., using Media Redundancy Protocol (MRP) on one side, and IEC 61850 network using Rapid Spanning Tree Protocol (RSTP) prioritization and a VLAN with Generic Object Oriented Substation Events (GOOSE) multicast on the other side). It is important to provide fall back functions of all redundant components with the required parameters (e.g., a synchronization between the primary and the redundant version may be required). Synchronization between redundant gateways may be done via a network port or serial connection 12c.

Thus, the gateway 12a, 12b may be located between a network 20 implementing IEC 61850 Manufacturing Message Specification, MMS, and the plant bus 21. The gateway 12a, 12b establishes the communication between the industrial controller 13 (e.g., an S7 proffered by Siemens), and the IEDs, or in general between the industrial controller(s) 13 and any other automation devices 11. To enable the communication, the IEC 61850 data is to be converted to data intelligible to the industrial controller. For example, in the case of an industrial controller 13 in the form of an S7, telegrams are to be created on the application layer. Telegrams are used for the (e.g., cyclic) data exchange between an industrial controller 13, such as an PLC, and the gateway 12a, 12b. There are different telegrams that contain different (e.g., cyclic) parameters and thus they are used for different kind of (e.g., control) applications(e.g., for motion control). There are a number of (e.g., several) types of telegrams in general: standard telegrams (e.g., telegram 1); proprietary telegrams (e.g., telegram 111); safety telegrams (e.g., telegram 30, used for safety integrated functions); free telegrams (e.g., used for user specific communication).

Hence, TCP/IP (e.g., according to RFC1006) may be used as a transport protocol between the industrial controller and the gateway (e.g., as well as between the gateway and the automation devices). This allows for a telegram-oriented communication between the industrial controller (e.g., more precisely, the control application) and the gateway (e.g., more precisely, the application layer component), for example, on top of the transport layer (e.g., on the application layer). Telegrams may be sent and received from the industrial controller and/or the gateway, respectively. The telegrams may be used to specify the data length and/or which type of data that is sent to and from the industrial controller.

Thus, a communication according to the ISO/OSI model may be created. TCP/IP and Ethernet may be used for the actual data transfer on the transport layer and below. Communication via telegrams on the application layer (and the presentation and/or session layer) enables event-driven (e.g., control) applications (e.g., the industrial controller 13 may trigger actions on the higher-or lower-level of the automation system 10). Thus, a first protocol may include an application layer protocol that implements functions, or data services, for exchanging data between the industrial controller, such as the SIMATIC S7 series or other PLCs, and the one or more gateways. Here, both ISO and/or TCP/IP may be supported as transport protocols.

The industrial controller 13 may include one or more data services (e.g., comprised in the control program), such as I_PUT/I_GET, X_PUT/X_GET, X_SEND/X_RCV, which are uni-/bi-directional data services that permit to fetch or write data of a communication partner (e.g., a device or a module), such as the gateway 12a, 12b, connected to the industrial controller 13.

Thus, the second protocol, such as eth S7 Protocol (RFC 1006), enables the connection of the industrial controller 13 with one or more other communication partners, such as the gateway 13 currently proposed. The second protocol thus provides direct access to the control program 40 or other data services running on the industrial controller 13. For example, the second protocol may allow access to the memory of the industrial controller 13 without changes in the control program itself. The control program 40 is also referred to as control application herein.

For example, the S7 Protocol (RFC 1006) supports a variety of different transportation methods. For the usage of TCP/IP, only a communication unit for Ethernet connection or alternatively an onboard Ethernet interface that supports ISOonTCP (RFC1006) is available.

The gateway 13 may also enable the time synchronization from the plant bus 21 to the automation devices (e.g., the IEDs) on the bay-level. However, the gateway 13 may not be used as a network router or firewall to connect both networks for other forms of communication (e.g., IED configuration or SNMP gateway).

The gateway 13 may be based on industrial computer (e.g., IPC227E as proffered by Siemens) that connects automation devices 11, such as IEC 61850 devices (e.g., from different vendors) to the industrial controller 13 (e.g., the S7 controller). The gateway may use two Ethernet RJ45 interfaces, eth0 and eth1: The IEC 61850 interface (eth1) is connected to the Ethernet network with the automation devices 11 (e.g., the protection relays) using the protocol IEC 61850 MMS. The interface (eth0) is connected to the industrial controller 13, such as the S7 controller (e.g., via the plant bus 21 using Industrial Ethernet). On both ethernet networks the IP protocol may be used with static IP addresses for the communication partners. The gateway 13 may buffer messages (e.g., with timestamps) from the IEDs (e.g., the protection relays) and transfers them (e.g., via the industrial controller 13) to the alarm system of an operator station 14 (e.g., the OS server). From the OS server, an OS station 14 or OS client may retrieve the alarms, or the messages in general. Via the operator system (OS), an easy and safe control of the process by the operating personnel is enabled. The operator may observe the process sequence using various views and intervene to control the automation system 10 when necessary. The operator system (OS) may be implemented by operator stations 14 for single-user systems or, as shown, for multi-user systems with client/server architecture.

Different types of data may be transferred (e.g., cyclically) from the automation devices 11, such as the IEDs (e.g., the protection relays), to the outputs of special function block(s) of an industrial controller 13 (e.g., a special function block in the form of a data service 41 or the control program 40 itself). The control program 40, also referred to as control application, may thus include one or more functions blocks. The data types may include BOOLEAN, BYTE, REAL, INTEGER, DOUBLE INTEGER, or the like. A data type may also include date and/or time of a data object of the one or more automation devices, such as the IEDs. As mentioned, IEC 61850 is an object-oriented standard. Each physical device may include one or more logical devices (LD), logical nodes (LN), data objects (DO), and data attributes (DA). A logical node includes mandatory and/or optional data objects. A data object may have predefined data attributes.

Up till now, a data type or data format conversion has been performed by the industrial controller (e.g., using the control application 40 or a data service 41, such as in the form of a function block, on the industrial controller). According to the present embodiments, a data format adaption (e.g., from the IEC 61850 MMS into the format of the control application 40 of the industrial controller 13) is performed on the gateway 12. The data format is a data format defined on the application layer and/or shared between the application layer component 31 on the gateway 12 and the control program 40 (or the data service) on the industrial controller 13.

A scan cycle time of the industrial controller 13 is one second or greater. Binary commands and interlocks are transferred from inputs of special function blocks in the industrial controller. In combination with the reporting mechanism for IEC 61850, one or more telegram (e.g., tags) representing different data types may be exchanged (e.g., event based) between the one or more automation devices, such as the IEDs, and the control application on the one or more industrial controllers 13 via the gateway 12 to reduce unnecessary load on the fieldbus (e.g., on the bay-level 20 and/or station-level 21).

The gateway 12a, 12b may be based on a standard industrial PC (e.g., a Siemens IPC227E). The operating system is an embedded Linux system. The gateway may include a web interface for diagnostic information. The gateway 12a, 12b may be used in single or redundant operation. The coordination with an optional redundancy partner is done via an Ethernet port or a serial interface 12c (e.g., depending on the parametrization in the web interface). The gateway may thus support the communication protocol IEC 61850 MMS Edition 1 and Edition 2.1. Both the overlayed systems (like PCS 7 PLC and WinCC) and the underlaid systems (like IEDs) may implement protections and interlocks to avoid damage of property or personal damage. The gateway 12a, 12b may thus supports the Edition 1, Edition 2.0 and/or 2.1 of the communication protocol IEC 61850 MMS.

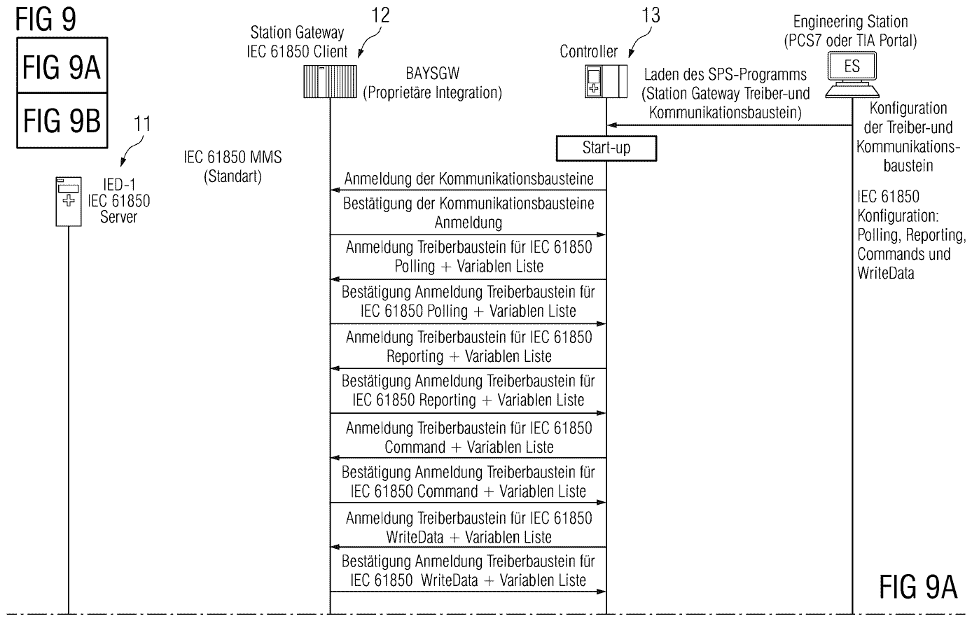

The industrial controller 13 and the gateway 12a, 12b are participants of a common Ethernet network, and may have static IP addresses. In the gateway 12a, 12b, only the IP address is to be defined for the communication with the industrial controller 13 (e.g., the CPU of the industrial controller 13, such as the S7 industrial controller). All other communication parameters for a second communication connection or communication link, such as the S7 communication shown in FIG. 1, are engineered in an engineering application ES, such as a PCS 7 engineering station, and therein mainly in the PCS 7 software tool NetPro. The PCS7 engineering station ES may establish a connection to the gateway. The one or more (e.g., each) CPUs of the industrial controller 13 may then be connected to the one or more (e.g., each) gateway 12a, 12b via a communication connection (e.g., an S7 connection). A redundant system as shown in FIG. 1 with two industrial controllers 13 and two gateways 12a, 12b would therefore need to have four communication connections defined, as, for example, shown in FIG. 8.

In any case, multiple connections from multiple gateways 12a, 12b to one automation device 11, such as the IED, are also possible (e.g., if the IED supports the required number of connections).

Thus, the gateway 12a, 12b may have two ethernet interfaces designated for the second network implementing a second protocol (e.g., an S7 protocol) and the first network implementing a first protocol, such as the IEC61850 MMS protocol. These are to be configured according to the existing networks so that communication with the industrial controller is possible via interface X1 and the connection to the IEDs via interface X2. The interface X1 (e.g., implementing the second protocol) and X2 (e.g., implementing the first protocol) is to be in different logical networks (e.g., different subnets). For example, if X1 is configured for network 140.80.0.0 (e.g., X1 default configuration), the interface X2 is not to be inside the same subnet.

Function blocks (e.g., PCS7 function blocks) in CFC refer to these connections via a connection ID, which may be given as a hex value. Continuous Function Chart (CFC) is an editor with a graphical user interface, an extension based on the STEP 7 software package. It is used to create the entire software structure of the CPU (e.g., of the industrial controller) and may use pre-configured function blocks. The editor enables creation and insertion of such function blocks into function charts, assign block parameters, and interconnect blocks. Interconnecting provides that values may be transferred from one output to one or more inputs during communication between the function blocks or other objects.

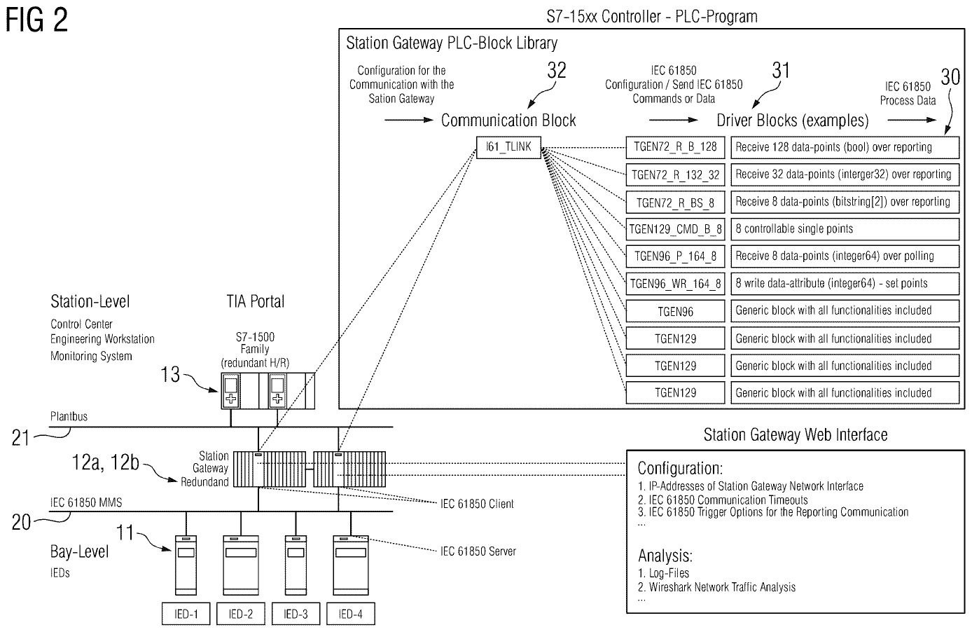

The CFC or another (e.g., suitable) engineering application may be used to configure the gateway 12a, 12b as well. To that end, a communication block may be created and/or configured to enable communication between the gateway 12a, 12b and the industrial controller 13. Such a communication block is shown in FIG. 2 and is used to receive and/or send messages such as application layer telegrams between the industrial controller 13 and the gateway 12a, 12b. The communication block 32 may be understood as a specific function block. Thus, such an application layer communication block may be loaded and/or executed on the gateway 13. The communication block 32 may thus include a communication stack for enabling physical, data link, network, transport, and/or transport communication. The communication block may, for example, enable processing of telegrams on the application layer. For example, the communication block 32 may process a header of an application layer telegram. The application layer telegram may include a header and other sections such as payload. Based on the process data received from the automation devices, the communication block 32 may put together an application layer telegram, and, for example, assign a header to the telegram, or vice versa, in case a telegram is to be mapped on the first protocol on the first network 20 and the payload to be transmitted to the one or more automation devices.

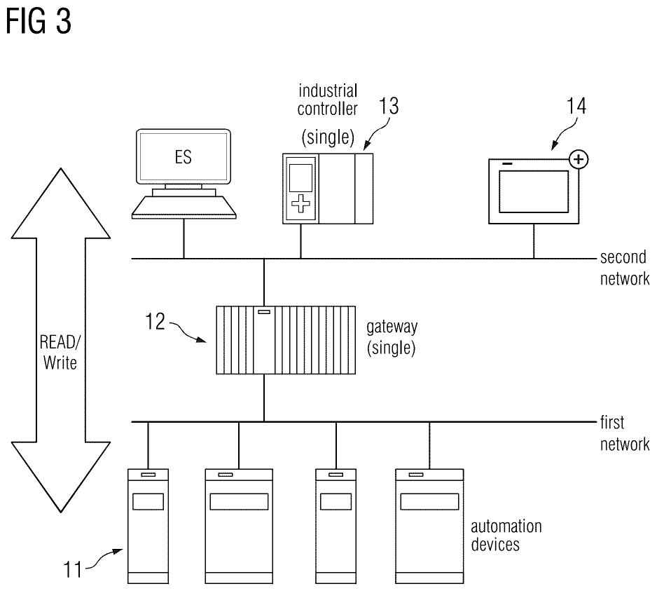

Thus, for example, via the function block 32, an application layer connection between the industrial controller 13 and the gateway 12a, 12b may be established. Hence, the communication block 32 may implement a communication endpoint of the control application (e.g., extending the control application via the application layer component onto the gateway). The communication block 32 may be understood as (part of) an application layer component 30 on the gateway 13 (e.g., stored on and/or executed by the gateway). A function block of the actual control application may thus be located on the industrial controller. The industrial controller may execute this function block as part of the control application (e.g., for controlling the automation system and/or the one or more processes in the plant). The communication block (e.g., of the control application) may be located on the gateway and communicatively couple the function block(s) on the industrial controller to the (e.g., communication block on the) gateway. The communication block may be coupled to one or more driver blocks that serve for communicating with the automation devices. As shown in FIG. 3, one or more driver blocks 31 may serve for communicating with each automation device on the first network (e.g., on the bay-level). The driver blocks 31 may also be part of the application layer component 30 of the gateway 13 and may thus also implement (e.g., part of) the communication endpoint of the control application (e.g., on the application layer; the control application of the industrial controller). Hence, the industrial controller 13 and the second network 21 (e.g., the plant bus) is effectively offloaded by the preprocessing of data received via the first network 20 (e.g., and the one or more automation devices).

In FIG. 8, a number of redundancy configurations are shown. One or more instances of the application layer component 30 (e.g., including the communication block 32 and/or driver blocks 31) may be executed and/or run in single and in redundant systems according to the redundancy functions of the automation system 10 including the one or more industrial controller and/or the one or more gateways. In FIG. 8, the first gateway SGW A and the second gateway SGW B including an instance (e.g., a single instance) of the application layer component (e.g., including the communication block and the one or more drivers). However, as the case may be, each gateway may include one or more instances of the application layer component 30 (e.g. including the communication block 32 and/or driver blocks 31).

The communication or function block I61_LINK, as shown, for example, in FIG. 2, manages the redundant communication with up to four connections (e.g., with the one or more industrial controller). Each connection is engineered as a single connection. All connections combined constitute a redundant connection. A redundant gateway pair 12a, 12b needs at least two connections to one communication block I61_LINK. Each connection may be monitored using hearth beat telegrams from both gateways. One connection is sufficient for the complete data transfer in both directions. If two connections are available, one connection (e.g., via one CP443-1 card) is dedicated to sending data only, and the other connection (e.g., via another CP443-1 card) is dedicated to receiving data only. The data transfer may be switched over to another connection of the same gateway after a data package is not acknowledged by the receiver.

Returning to FIG. 2, the function block I61_LINK is the interface to the gateway 12a, 12b for the specific function blocks on the industrial controller 13. The function block I61_LINK coordinates and executes the data exchange between the function blocks on the industrial controller and the gateway. The inputs may contain the ID of the used connections. The driver blocks 31 are connected to a gateway by binding their input element to the output element of the function block I61_LINK. In the configuration program CFC, the connection may be graphically established. The function block I61_LINK accepts up to a predetermined amount of connected driver function blocks. If more than the predetermined amount of automation devices are to be connected, a second function block I61_LINK block may be used. The connected function blocks may run in a slower cycle than the function block I61_LINK block. Each specific (IEC 61850) driver function block may need a registration in the connected function block I61_LINK.

FIG. 3 shows a network topology including an industrial controller 13 (e.g., a single industrial controller 13), such as a S7-1500 proffered by SIEMENS. The gateway 12 connects automation devices, such as the IEC 61850 devices (e.g., from different vendors), to an industrial controller 13 and/or an engineering application on an engineering station ES such as the TIA Portal system. As mentioned before, the gateway 12 design may be based on a standard industrial PC, such as Siemens IPC227E. The operation system of the gateway 12 may be an embedded Linux system. The gateway may use two Ethernet RJ45 interfaces: The IEC 61850 interface (eth1) is connected to the Ethernet network with the protection relays using the protocol IEC 61850 MMS. The interface (eth0) may be connected to the CPUs of the engineering station (e.g., the TIA Portal) via the open Industrial Ethernet (IE) interface. On both ethernet networks, the IP protocol is used with static IP addresses for the communication partners. The gateway 13 operates as an IEC 61850 client, while the protection relays function as IEC 61850 servers. In order to provide network security, direct communication between both networks over the Station Gateway is not possible.

The gateway is configured and/or operative for the communication of automation devices 11, such as IEDs, to project specific control application software in one or more industrial controllers 13, such as S7-400 or S7-400H proffered by SIEMENS. For this purpose, a library with (IED-) driver blocks may be comprised in the gateway (cf., FIG. 2). The function blocks for the communication with the gateway 12 are using the system function blocks (e.g., BSEND and BRCV; in the CPU) of the industrial controller 13. These function blocks may be comprised in the industrial controller (e.g., S7-400) and/or in its CPU module, respectively.

The gateway 12 may provide a web interface on the network interface (eth0) (e.g., on port 8080 (enter ‘http://xx.xx.xx.xx:8080’) connecting it to second network, in which the industrial controller and/or the engineering station is located in)). The gateway 12 may be accessed from an engineering station or another service PC with an internet browser.

The gateway 12 may include or even consist of an Industrial PC, such as IPC227E. The operation system may be an embedded Linux system where the gateway's APIs run. The gateway 12 provides a web interface for diagnostic information and configuration. The gateway 12 may contain a function block library, as, for example, described in connection with FIG. 2. This library is used on the industrial controller to establish the connection with the gateway, to configure the IEC 61850 communication, to receive the (e.g., IEC 61850) process data (e.g., from the automation devices), and to send (e.g., IEC 61850) commands and data (e.g., to the automation devices).

As discussed herein, different setup options, such as redundancy, are possible. The gateway 12 may include a (e.g., software) client (e.g., an IEC 61850 client) for receiving data via the first network 20 from one or more (e.g., IEC 61850) servers (e.g., using buffered reporting, buffered report control block BRCB, and unbuffered reporting, unbuffered report control block URCB). Static and dynamic datasets may be supported as well. The IEC 61850 data-types Bool, BitString, Float, Integer, Integer32, and Integer64 may also be supported. The values of the data-attributes are transmitted with quality-code and timestamp.

It is also possible to write data to attributes of the IEC 61850 servers from the (e.g., control program of the) industrial controller 13. This functionality may support the following data-types: Bool, BitString, Float, Integer, Integer32, and Integer64. The industrial controller and/or its CPU may support the standard system function blocks from the TCON family, which use the open Industrial Ethernet (IE) interface from the industrial controller to establish a connection with the gateway. Both redundant (H/R) and single industrial controllers may support open IE communication.

The block library contains a communication block and different driver blocks than the ones shown in FIG. 2. The communication block 32 is used to establish communication with the gateway(s), where the entire configuration of the communication between the industrial controller 13 and the gateway(s) 12 is done (e.g., no extra configuration on the industrial controller hardware in TIA Portal is required for the gateway). The different driver blocks 31 are connected to the communication block 32. The driver blocks 31 may be used to configure the IEC 61850 data points to be read (e.g., via reporting or polling) and to specify commands and attributes to be sent/written. The (e.g., IEC 61850) process data from the automation devices 11 is received by the driver blocks 31. The commands and data are sent from the driver blocks 31 to the automation devices 11. The specification of the IEC 61850 data or command points is done based on the IEC 61850 Standard MMS syntax.

On the first network (e.g., the IEC 61850 network), the gateway 12 operates as an IEC 61850 client, and the Intelligent Electronic Devices (IEDs) operate as IEC 61850 servers. The communication protocol Manufacturing Message Specification (MMS) is also supported by the gateway. The gateway's (e.g., IEC 61850) client (e.g., same API) may communicate with (e.g., IEC 61850) servers, which, for example, communicate over IEC 61850 Ed. 1.0, Ed. 2.0, and Ed. 2.1.

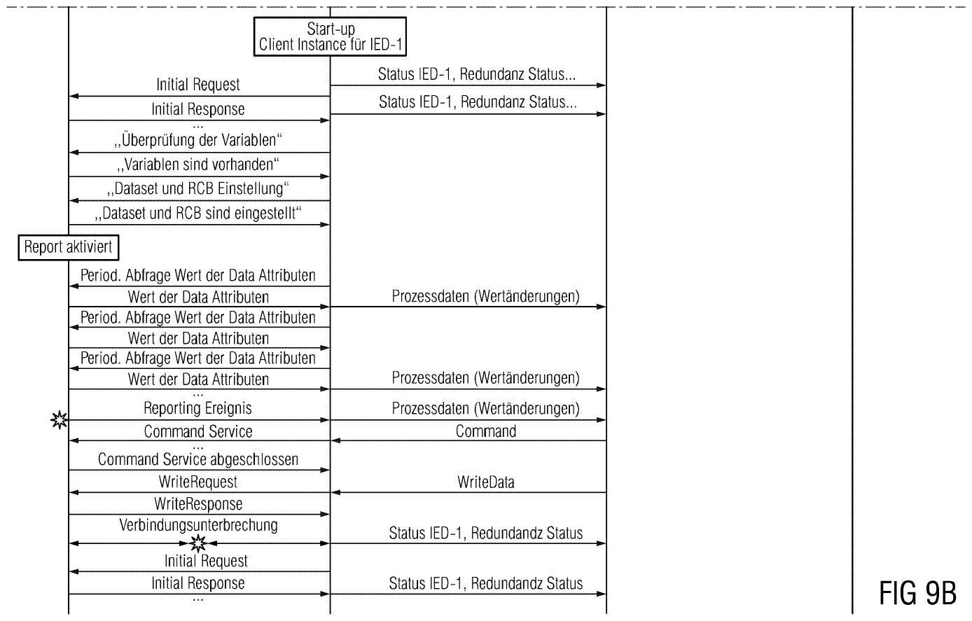

The communication with the gateway 12 from the industrial controller's side (e.g., the second network) is handled via the communication block I61_TLINK. However, the IEC 61850 configuration (e.g., configuring the gateway 12 as a client on the first network) is done using the driver blocks. The driver blocks are connected to an instance of the communication block I61_TLINK. After the controller startup procedure, the driver blocks' configuration (e.g., the gateway's client configuration) is transferred to the gateway 12, as shown in FIG. 9. Based on this configuration, the one or more (e.g., IEC 61850) client instances are started on the gateway 12. After this process, the (e.g., IEC 61850) process data received by the gateway's client is sent directly to the respective driver block instances. Commands and data may be sent to the respective server on the one or more automation devices (e.g., the IED, IEC 61850 server, using the driver blocks).

The gateway 12 is located between the first network (e.g., operating according to the IEC 61850 protocol) and the second network (e.g., operating according to a control system network). The gateway establishes the communication between the industrial controller 13 and the automation devices 11 (e.g., the IEDs). To enable the communication, the IEC 61850 data is converted to special telegrams (e.g., the data format of and/or suitable for processing by the control application) by the communication block of the gateway and vice versa. The gateway cannot be used as a network router or firewall to connect both networks for other forms of communication (e.g., IED configuration or SNMP gateway).

As mentioned, the block library of the gateway contains a communication block 32 and different driver blocks 31. The communication block 32 is used to establish communication with the gateway(s), where the entire configuration of the communication between the industrial controller 13 and the gateway(s) 12 is done (e.g., no extra configuration on the controller hardware, such as in the TIA Portal, may be required for the gateway). The different driver blocks 31 are connected to the communication block 32. The driver blocks 31 are used to configure the IEC 61850 data points to be read (e.g., via reporting or polling) and to specify commands and attributes to be sent/written. The IEC 61850 process data is received by the driver blocks. The commands and data are sent from the driver blocks. The specification of the IEC 61850 data or command points is done based on the IEC 61850 Standard MMS syntax.

The driver blocks 31 may be divided into a plurality of (e.g., five) groups based on the functionality: 1. “Commands”: Send the different command types SPS, DPC, INC, ENC, BSC, ISC, APC and BAC; 2. “Polling”: Read data periodically; 3. “Reporting”: Read data over “events” (e.g., using static or dynamic datasets—respectively using BRCBs or URCBs); 4. “WriteDataAttributes”: Write data in data-attributes from the IEC 61850 server; 5. “Generic”: Generic block containing all the command, polling, reporting and write-data functionalities.

The driver block-instances are to be connected to a I61_TLINK-instance (e.g., a communication block instance), as specified in FIG. 2. Multiple gateway setups may be used with the same industrial controller 13. In this case, the maximal number of application layer components 30 (e.g., including the one or more communication blocks 32 and/or driver blocks 31) may variate depending on the industrial controller's capacity.

The communication block 32 is used to establish communication with the gateway(s), where the entire configuration of the communication between the industrial controller and the gateway(s) is done (e.g., no extra configuration on the controller hardware in TIA Portal may be required for the gateway). Multiple instances of this block may be used in parallel respecting the characteristics of the maximal capacity. Thus, the function blocks, as described herein, are running in single and in redundant configuration according to the redundancy functions of the industrial controller 13.

In redundant mode, two gateways 12a, 12b are working as two (e.g., IEC 61850) clients with individual connections. To setup a redundant gateway 12a, 12b, two singular IPC227E Station Gateways may be paired to one redundant Station Gateway. The function block for an automation device, such as an IEC 61850 device, in the engineering tool, such as a PCS 7 station, may be used to configure the operation of the redundant gateways 12a, 12b. Additionally, some information may be exchanged between the redundant partners via a redundancy connection. This redundancy connection may be implemented via a serial COM1 or other network port (e.g., 12c as shown in in FIG. 1).

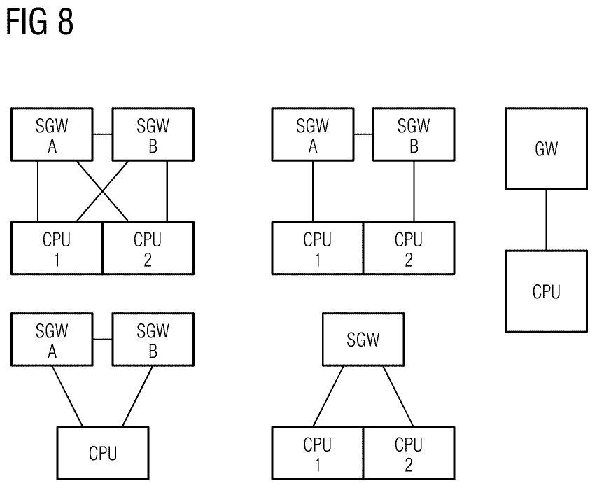

Each gateway 12a, 12b of a redundant pair is an independent client of an (e.g., IEC 61850) automation device 11. Both gateways 12a, 12b are receiving data from each automation device (e.g., IEC 61850 device) at the same time. But only one gateway transfers the data to the industrial controller 13 and its CPU, respectively, and only one gateway writes commands into the appointed automation device 11 (e.g., the IEC 61850 device). The data transfer to the industrial controller 13 and its CPU, respectively, and to the automation device 11, such as the IEC 61850 device, is not necessarily concentrated in one gateway 12a, 12b for all automation devices 11, such as the IEC 61850 devices, as, for example, shown in FIG. 7. Each gateway 12a, 12b may transfer the data of a first group of automation devices(e.g., the IEC 61850 devices), whereas another gateway transfers the data of a second group of automation devices. The role of a gateway for an automation device(e.g., the IEC 61850 device) may be managed in the industrial controller and by its CPU, respectively, by the function block for this automation device (e.g., the IEC 61850 device).

The function block I61_TLINK (e.g., on the application layer, such as the application layer component) manages the redundant communication with up to four TCP/IP connections. Each TCP connection is engineered as a single connection. All connections combined constitute a redundant connection. A redundant gateway pair 12a, 12b needs at least two TCP connections to one function block I61_TLINK. The different supported operation modes in combination with the different industrial controllers are represented in FIG. 8. In the picture, each line between the gateway(s) and the controller(s) represents a TCP/IP connection.

An address of an IEC 61850 MMS data-point is constructed from a number of (e.g., several) parts: the IED Name (e.g., IED_0081), Logical Device (LN, e.g., PROT), Logical Node (LN, e.g., PTOC6), Functional Constraint (FC, e.g., ST), and so on. This IED name may be identical for all data-points of a device. Therefore, the IED name may be omitted when addressing the data-points. The gateway then adds the name automatically.

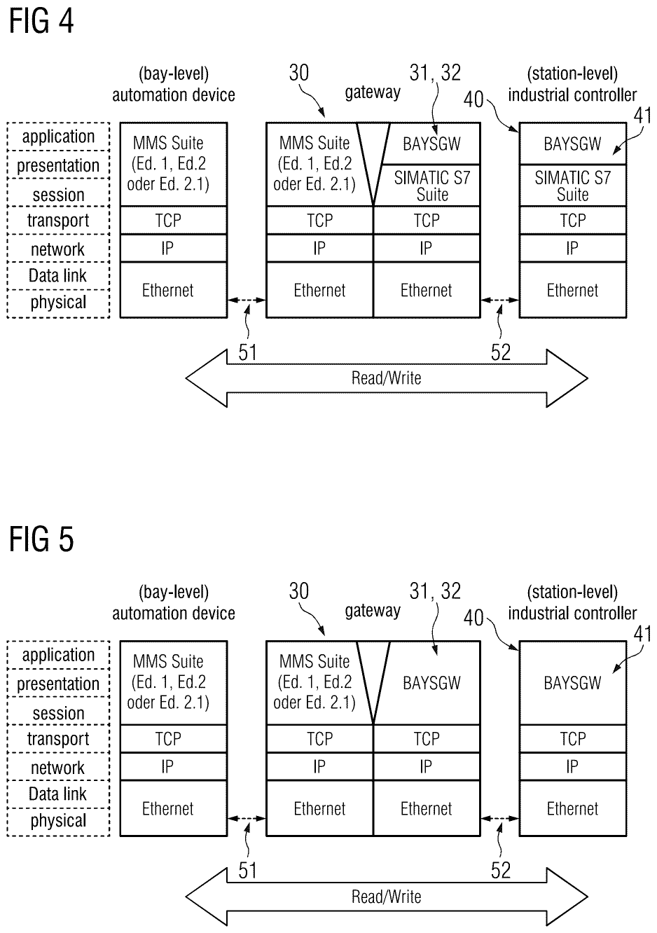

Turning to FIG. 4, an overview of the communication stacks of an automation device, a gateway, and an industrial controller is provided. The layer model according to Open Systems Interconnection (OSI) model is a reference model from the International Organization for Standardization (ISO), which is provided in FIG. 4 as a reference. For the lower layers including the transport, network, data link, and physical layer, TCP, IP, and Ethernet may be used in the communication stack of the one or more automation devices 11 in the first network (e.g., on the bay-level), the gateway 12, and the industrial controller 13 on the second network (e.g., on the station-level). Now, the one or more automation devices may make use of IEC 61850 MMS, which is a client/server-based protocol for communications between IEDs on the session, presentation, and the application layer. This MMS Suite provides a range of functions that allows the client on the gateway to obtain the data model of the server on the automation device, read or modify individual values, and delete entries as well as transfer files. The IEC 61850 (IEC 61850—Communication Networks and Systems in Substations) standard defines the Manufacturing Message Specification (MMS) protocol as a server/client type communication. This protocol is typically used for information exchange between Intelligent Electronic Devices (IEDs) and higher-level devices (e.g., such as an industrial controller or a SCADA system) over the Ethernet. The MMS protocol is mapped on TCP/IP and enables the access to a server based on its IP address where the client on the gateway may read/write data and read configuration and exchange files on the automation device. IEC 61850 is an object-oriented standard. Each automation device is described as logical device(s) (LD), logical node(s) (LN), data objects (DO), and data attributes (DA).

The gateway 12 may include two communications stacks, where the first stack serves for communicating over the first network with the automation device, and the second communication stack serves for communicating over the second network (e.g., with the industrial controller or an engineering application, such as on an engineering station). On the bay-level side, the process data, or data in general, is received by the gateway and processed according to the of IEC 61850 MMS by a client instance on the session, presentation, and application layer. Then, the data in accordance with the MMS protocol is mapped on the application layer (e.g., by an application layer component 30), for example, in accordance with an application layer protocol (e.g., of the control application), to the format of the control application. Hence, the gateway may implement a communication endpoint for the communication of the automation device with the industrial controller.

The data in the format of the control application may then be forwarded in accordance with an application layer protocol (e.g., as well as the presentation layer protocol and the session layer protocol, as the case may be) of the control application to the control application 40 or a data service 41 on the industrial controller. To that end, the data in the format of the control application 40 is encapsulated again according to the lower layers' protocols and transmitted to the industrial controller.

The industrial controller thus receives the process data from the automation device and processes the process data according to its protocol stack including a transport, network, and physical layer protocols, and in accordance with the session, presentation and/or application layer protocol of the control application. Thus, the control application is extended via the application layer component onto the gateway.

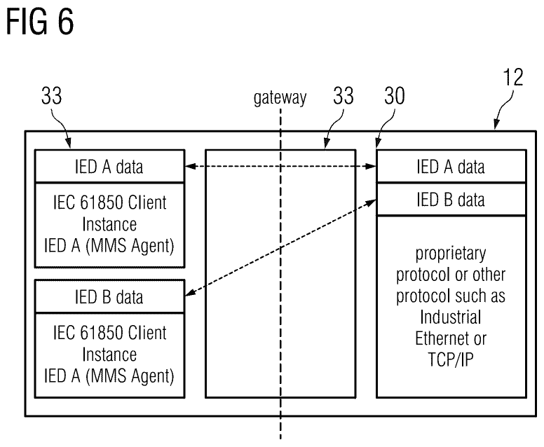

The protocol layer corresponding to the session, presentation, and application layer protocols of the gateway and of the industrial controller are referred to as BAYSGW in FIGS. 4 and 5. Hence, the gateway includes a (pre-)processing (e.g., of the process data of the automation devices) on the application layer (e.g., in accordance with the application layer protocol of the control application. The gateway thus includes, for example, from the point of view of the automation device, a communication endpoint 33 in the form of an application layer component. This application layer component performs data processing in accordance with the control program of the industrial controller. The application layer component on the gateway and the control application (e.g., or data service) on the industrial controller are referred to as BAYSGW, respectively, in FIGS. 4 and 5. As described herein, BAYSGW may include the one or more function blocks (e.g., the communication blocks as described herein, such as shown and described in connection with FIG. 2), and the industrial controller may include one or more function blocks (e.g., as described in connection with FIG. 2) for controlling the automation system. The automation system 10 may include the automation device(s) and/or the process to be controlled. Thereby, a modular processing of the data is achieved, where a first processing (e.g., pre-processing) is performed on the data received from the automation devices at the application layer of the gateway, and a second processing (e.g., further processing) is performed on the application layer of the industrial controller including the control application.

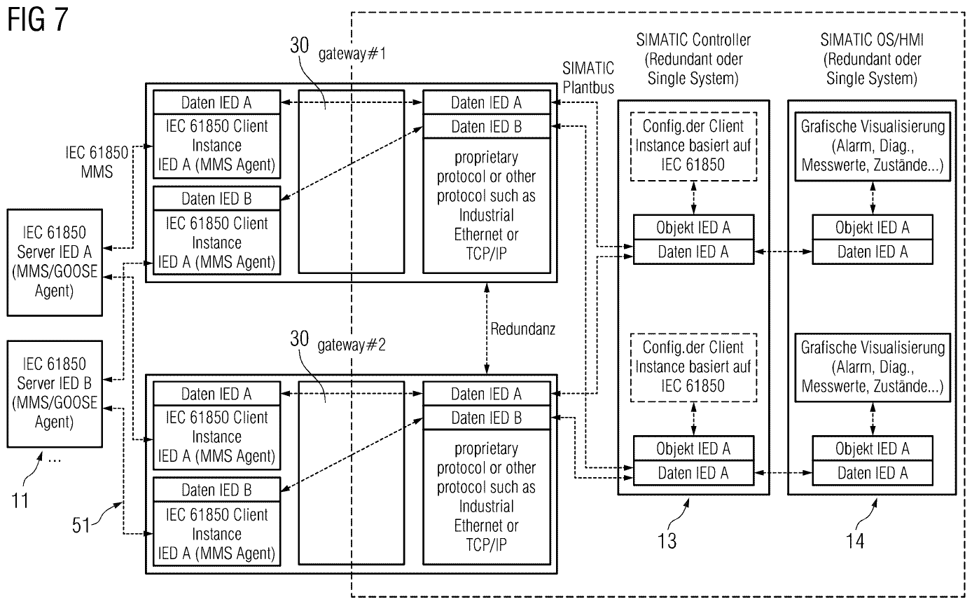

In FIG. 6, the communication endpoint 33 on the application layer of the gateway is visualized. The gateway 12 thus includes one or more application layer components 30 implementing a communication endpoint 33 of a first communication link between the one or more automation devices and the gateway. This communication endpoint 33 terminates the connection (e.g., on the application layer) between the automation devices and the control application on the industrial controller. The gateway 12 may include a first client instance for data transmission to and/or reception from an automation device (e.g., data may be received from IED A), and a second client instance for transmission and/or reception from a second automation device (e.g., IED B). The communication endpoint 33 may be part of an application layer component 30 that maps the data from IED a and IED B onto a format corresponding to the format of or suitable for the control application. To that end, the application layer component 30 may also invoke presentation layer and/or session layer protocols or protocol elements (e.g., corresponding header of telegrams for data transmission within the layers). Protocol layers below the application layer (e.g., and/or the presentation and/or session layer), however, may remain unaffected and may, for example, include industrial ethernet, TCP/IP, or a proprietary protocol on the transport, network, data link, and physical layer.

Turning to FIG. 7, a redundant setup of an automation system 10 is illustrated. Similar to the gateway shown in FIG. 6, two automation devices 11, for example, incorporated as IED devices including respective server instances functioning in accordance with IEC 61850 MMS/GOOSE standard are shown. Two redundant gateways #1, #2 are connected to the automation devices 11, where each gateway #1, #2 is set up as described herein in connection with FIG. 6 (e.g., with individual communication links; over a first network) to the automation devices 11, illustrated by the dotted lines in FIG. 7. The redundant gateways terminate the communication between the automation devices 11 and the control application on the industrial controller 13. Similarly, the gateways #1, #2 terminate the communication between the automation devices 11 and the alarm management and/or event handling and visualization application on an operator station 14, such as an HMI or any other operator interface.

As described herein, the gateways #1, #2 pre-process the process data from the automation devices 11 and not only convert the protocols from the first network to the second network on the lower layers, but in addition, an application layer processing and format adaptation is performed in order to match the (e.g., process) data to the format of the control application and to make it suitable for processing by the control application. Thus, the gateway(s) #1, #2 acts as a terminal that ends the communication link 51 of the automation devices. A communication endpoint may be understood as a type of communication network node. The communication endpoint may be understood as an interface exposed by the control application of the industrial controller, where it is proposed herein to locate this interface (e.g., the communication endpoint on the gateway). The application layer component (e.g., implemented in software, such as program code) serves as a communication endpoint that is used by the underlaying transport layer protocol, such as User Diagram Protocol (UDP) and Transmission Control Protocol (TCP). A communication endpoint may thus be understood as an entity on one end of a transport layer connection. A communication endpoint may thus be understood as a set of communication resources that allows the control program to interface with the network hardware to transmit and/or receive data over the (e.g., first) network and thus communicate with the automation devices. The communication endpoint may thus serve for sending or receiving data between the automation devices (e.g., and their respective (embedded) control software) and the control application. The communication endpoint thus (e.g., logically) links the control application to first network (e.g., and thus the automation devices on that network). A communication endpoint may be defined by a socket (e.g., IP address+port). The automation device may thus establish a logical connection with the control application via the communication endpoint on the gateway. This logical connection allows the one or more automation devices to exchange data with the control program. The communication endpoint defines that this exchange happens on the gateway and is implemented by the application layer component on the gateway.

As described herein, there may also be a redundancy connection provided between the gateways. Further, the gateways and the respective application layer components may be connected with a plurality of application layer application (e.g., instances), such as function blocks and/or control programs in general, on the one or more industrial controllers and/or engineering stations and/or operator stations in accordance with the type of redundancy implemented in the automation system. As shown in FIG. 7, each application layer component and respective instance is connected to a (e.g., part of a) control program or other application on the application layer that further processes the processes at the automation devices. Here, the gateway #1 is connected to a data object in the industrial controller for processing the data of IED A. The gateway #2 is connected to the same industrial controller and the same data object for processing the data of IED A. The same applies for the data of IED B, which is transmitted over the second network (e.g., a SIMATIC plantbus) to the industrial controller and an application for processing the process data of IED B. Hence, the gateway, via the application layer component, maps the process data of the automation devices onto the data model or control model of the industrial controller and the control application respectively. The gateway application layer component recognizes which control model the object is using and performs the command operation as required. The same control model may also be used by the engineering station and/or operator station.

Hence, a gateway is provided, where the application layer component is operative to delay transmission of the received automation data in the application layer format to the control application via the second transport protocol (e.g., delaying and waiting for acknowledge of reception and/or processing of previous data by the control application). The application layer component of the gateway may be operative to monitor and/or analyze the reception of the automation data in the first data format in the first transport layer protocol. The application layer component may be operative to store the (e.g., pre-processed) automation data(e.g., in case the control application is unavailable, for example, due to an interruption of a network communication between the gateway and the industrial controller). The application layer component may be operative to duplicate and/or repeatedly transmit the data received from the one or more automation devices to one or more control applications on one or more industrial controllers (e.g., for redundantly transmitting the pre-processed data to a plurality industrial controller).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A gateway for communicatively coupling one or more automation devices to an industrial controller for controlling the one or more automation devices, the gateway comprising:
an application layer component configured to implement a communication endpoint of a control application of the industrial controller.

2. The gateway of claim 1, wherein the one or more automation devices are IEC 61850 devices.

3. The gateway of claim 1, wherein the communication endpoint is configured to terminate a communication connection of an application layer data service of the control application.

4. The gateway of claim 1, wherein the gateway is configured to transmit pre-processed data in an application layer format to the control application on the industrial controller, and/or vice versa.

5. The gateway of claim 1, wherein the communication endpoint comprises a communication interface that enables a first communication link between the one or more automation devices and the gateway, and
wherein the communication endpoint enables a logical connection between the automation devices and the control application on the industrial controller.

6. The gateway of claim 1, wherein the application layer component is configured to:
process data received in a first data format from the one or more automation devices via the first communication link using a first transport-layer protocol; and
transmit the data to the control application on the industrial controller in a second data format via a second communication link using a second transport-layer protocol between the gateway and the control application on the industrial controller.

7. The gateway of claim 1, wherein the application-layer component is configured to:
receive data over the first communication link; and
convert the data from the first data format into an application-layer format compatible with a control application of the industrial controller, such that the data is processable by the control application.

8. The gateway of claim 1, wherein the application layer component is operative to transmit the data in the application layer format via a second transport layer protocol to the control application on the industrial controller.

9. The gateway of claim 1, wherein the application layer component on the gateway comprises a server configured to transmit the data in the application layer format to a client of the control application on the industrial controller.

10. The gateway of claim 1, wherein the application layer component on the gateway comprises a client operative to receive the data in the first data format from a server on the one or more automation devices.

11. The gateway of claim 1, wherein the client on the gateway is an IEC 61850 client and is operable to load one or more driver components for communicating over the first communication link with the one or more automation devices.

12. The gateway of claim 1, wherein the application layer component is configured to pre-process the data from the automation devices into the application layer format.

13. The gateway of claim 1, wherein the application layer component is configured to map the data received from the one or more automation devices onto one or more data objects of the application layer format, as used, defined, or used and defined by the control application data model.

14. The gateway of claim 13, wherein the application layer component is configured to map a quality code byte input variable from the one or more automation devices into byte variable of an application layer format.

15. The gateway of claim 1, wherein:
the application layer component and the control application use a same application layer format
the automation data obtained from the one or more automation device and not necessary for the control of the automating devices by the control application are discarded by the application layer component; or
a combination thereof.

16. The gateway of claim 15, wherein shared data format has a common semantic, syntax, or semantic and syntax.

17. A system for distributed automation data processing, the system comprising:
a gateway; and
an industrial controller,
wherein the gateway comprises an application layer component that implements a communication endpoint of a control application of the industrial controller, and
wherein the application layer component on the gateway is configured for pre-processing the automation data into an application layer format suitable to be processed by the control application on the industrial controller.

18. A method of operating a gateway in an industrial automation system, the method comprising:
implementing, by an application layer component, a communication endpoint of a control application or an application layer data service of an industrial controller for controlling one or more automation devices by terminating one or more communications links between the gateway and the one or more automation devices.

19. In a non-transitory computer-readable storage medium that stores instructions executable by one or more processors to operate a gateway in an industrial automation system, the instructions comprising:
implementing, by an application layer component, a communication endpoint of a control application or an application layer data service of an industrial controller for controlling one or more automation devices by terminating one or more communications links between the gateway and the one or more automation devices.
